(19) United States
(12) Patent Application Publication
(10) Pub. No.: US 2002/0090103 A1
(43) Pub. Date: Jul. 11, 2002

(54) Personal wearable audio system

(76) Inventor: Russell Calisto JR., North Hills, PA (US)

Correspondence Address: Richard W. Goldstein, 2071 Clove Road, Staten Island, NY, 10304, US

(21) Appl. No.: 09/755,540

(22) Filed: Jan. 8, 2001

(51) Int. Cl. H04R 1/02; H04B 1/034; H04R 9/06

(52) U.S. Cl. 381/333; 381/301; 381/87; 381/334; 455/100; 455/351

(57) ABSTRACT

A wearable personal audio system to audibly deliver audio information, even at a low volume level, to the wearer. The system includes an audio unit, and at least one miniature speaker, that are located within and suitably fixed to the article of clothing so as to be supported in an unseen manner. Each speaker is operatively coupled to the audio unit to enable audio information from the audio unit to be audibly delivered to the wearer via the speakers.

### BACKGROUND OF THE INVENTION

1. Field of the Invention

The invention relates generally to audio systems. More particularly, the present invention relates to wearable, personal audio systems that is incorporate audio components within an article of clothing.

2. Background and objects of the Invention

Audio information delivery systems may be divided into two fundamental categories: stationary/fixed systems and mobile/portable units. The former group includes audio systems that are large and or fixed in position at a particular location. The latter group (mobile/portable), includes portable audio units that are quite compact, for example the ubiquitous belt mountable radio/cassette systems that employ a small pair of headphones. These units enable the private delivery of audio information, generally music, to a user-wearer. However, these units are still somewhat bulky and if worn for a significant length of time, the headphones can become quite uncomfortable. These facts are especially the case when used by individuals engaging in physical exercises such as bicycling, running, or climbing.

Another very compact audio unit known in the art is provided by a headphone arrangement wherein the audio unit, typically an FM radio, is located within the headphones themselves. Although very compact and portable, these systems suffer from the same problems as the above listed headphone units.

Objects of the present invention are, therefore, to provide new and improved personal audio systems having one or more of the following capabilities, features, advantages, and/or characteristics:

a very compact modular system worn by a user;

components of the personal audio system may be fixed and supported in an unseen fashion ‘within’ an article of clothing;

reliable and low maintenance system using many off-the-shelf parts;

arranged to operate so as to deliver to the wearer a wide variety of audio information including music, audio instructional messages of many possible types, directions to execute and complete one or more specific tasks;

including very small and compact speaker elements ergonomically positioned to support the efficient delivery of audio information to the wearer (even at a low volume); and

simple and economical construction.

The above listed objects, advantages, and associated novel features of the present invention, as well as others, will become more clear from the description and figures provided herein. Attention is called to the fact, however, that the drawings are illustrative only. Variations are contemplated as being part of the invention, limited only by the scope of the appended claims.

### SUMMARY OF THE INVENTION

In accordance with the invention, a personal audio system is provided within an article of clothing, which when being worn, enables audio information to be audibly delivered to a wearer. The personal audio system includes the article of clothing having suitably fixed and supported thereon an audio unit and at least one speaker element, which is also suitably fixed to and supported by the article of clothing. Coupling means, such as insulated electrical conductors, and employed to enable each included speaker element to be operatively coupled to the audio unit to enable audio information from the audio unit to be coupled to the speaker elements and audibly delivered to the wearer.

The speaker elements may be ergonomically located and positioned upon (or within) the article of clothing to facilitate the delivery of low volume audio information to the wearer, without the need for headphones. Accordingly, the speaker elements are contemplated to be provided by embodiments having a very low profile type design, possibly being somewhat ‘flexible’.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of many possible arrangements utilizing the fundamental concepts of the present invention. As such, the embodiments provided should be considered illustrative only. The drawings are briefly described as follows:

FIG. 1 illustrates an embodiment of the wearable personal audio system in accordance with the present invention.

FIG. 2 depicts system components of the figure FIG. 1 embodiment, separated from an article of clothing they would be supported upon and or housed within.

FIG. 3 illustrates a second possible embodiment of the invention.

### List of Reference Numerals used in the Drawings

10—(wearable) personal audio system

12—audio unit

14—article of clothing

16—speaker element

20—coupling means

22—switch means (pressure sensitive)

24—battery pack

26—connector

30—second embodiment of the personal audio system

### DETAILED DESCRIPTION OF THE PREFERRED EMBODIMENTS

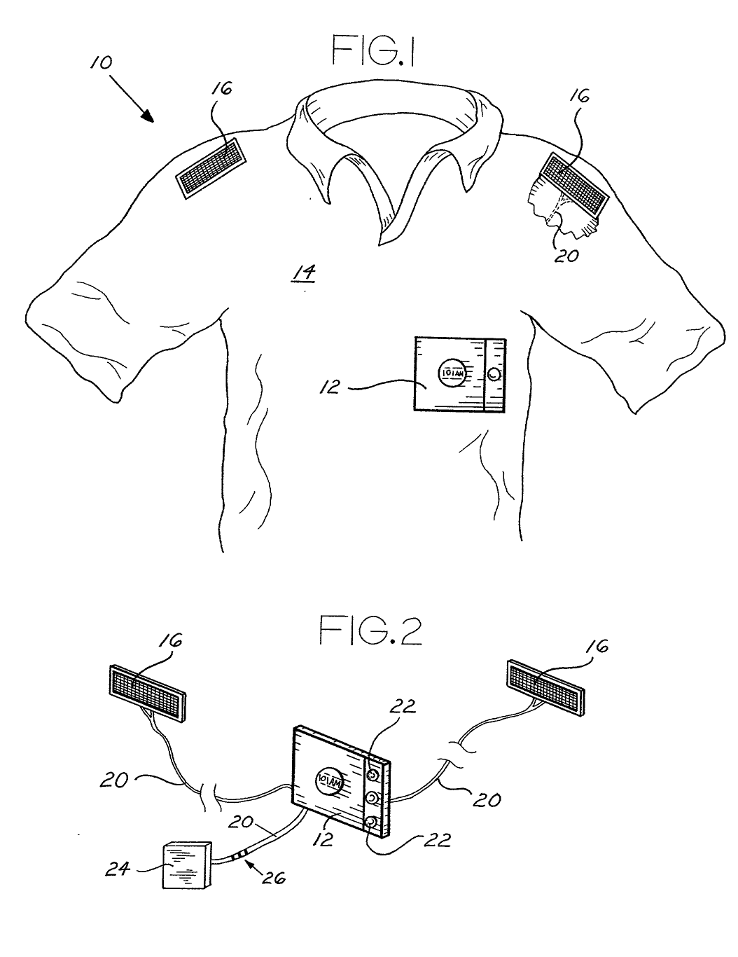

It is important to establish the definition of several important terms that will be used throughout this disclosure. The term ‘audio unit’ is to be defined in a generic and broad fashion, and is intended to include any small compact module or unit that can provide audio information to a suitable speaker device. As such, the audio unit may be any of an AM/FM radio (or the like), a cassette or CD-ROM playing device, or a receiver that may receive audio information via wireless or optical signals. The term ‘article of clothing’ may be assumed to indicate any wearable clothing item including shirts, vests, jackets, pants, shorts, etc. Other terms and definitions will be provided as required. Referring now to FIG. 1, there is illustrated a wearable personal audio system 10 in accordance with the present invention. Shown is an article of clothing 14 with an audio unit 12 suitably fixed to and supported by the article of clothing. At least one speaker element 16, which is also suitably fixed to and supported by the article of clothing 14, is included to enable information that is coupled from the audio unit 12 to be audibly delivered to a wearer (of the article of clothing 14). Accordingly, and as clearly seen in FIG. 2, a suitable coupling means 20 is provided to enable each included speaker element 16 to be operatively coupled to the audio unit 12.

As can be shown in FIG. 1, the audio unit 12 and speaker elements 16 may be ergonomically situated and fixed to the article of clothing 14. For example, the location of the speaker elements 16, as depicted in FIG. 1, will facilitate the audible delivery of relatively low volume audio information to the wearer. Also, the audio unit 12 would typically be located in a position wherein the wearer readily can activate and adjust the controls of the audio unit 12. For example, it is contemplated that a switch means 22 may be provided to adjust the settings of the audio unit 12, such as the volume of the audio information coupled to each speaker element 16.

Referring again to FIG. 2, a discrete battery pack 24 may be included with the personal audio system 10. In a preferred embodiment of the invention, the battery pack 24 would be removable, possibly held in an interior pocket or an equivalent ‘holder’, and would be coupled to the audio unit 12 by coupling means 20. A connector 26 may be included to disconnect the battery pack 24 for service or replacement when the batteries included therein are drained (possibly needing to be recharged, for example).

It should be noted that although not illustrated, that the present invention may be configured with solar cells, say, located upon the upper back region of the article of clothing 14 (of FIG. 1). Accordingly, the present invention may be configured to be, at least partially, solar powered. It is also important to note that the audio information delivered to the wearer may include music, operational instructions, or a wide variety of educational, instructional, or descriptive audio information. Further, the audio information may be provided on a fixed content, insertable media, such as digital compact disks (e.g., CD-ROM) and miniature audio cassettes, and or transmitted to and received by the audio unit 12. Transmitted information may be received via wireless or optical signals (and techniques).

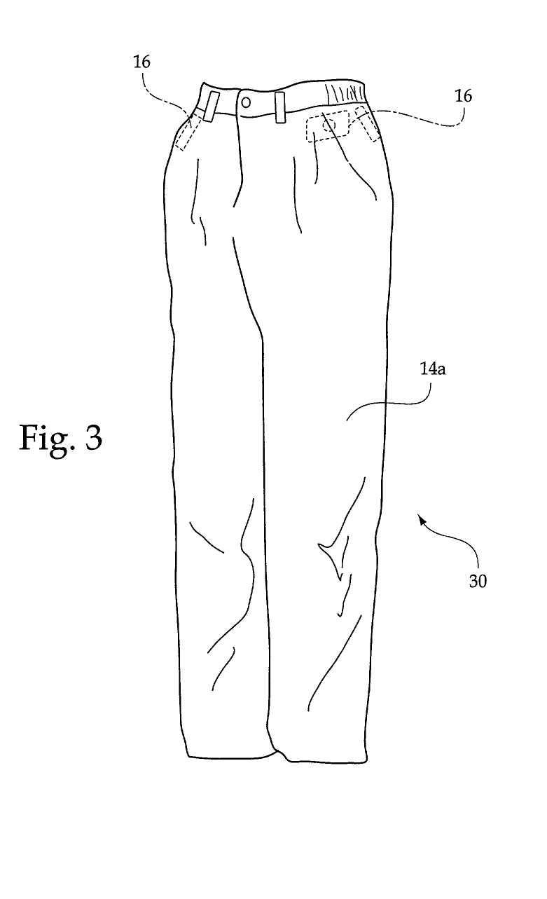

An alternate embodiment of the invention 30, as can be seen in FIG. 3, is provided with the article of clothing provided by pants 14a. The audio components of FIG. 2 would be suitably ‘installed’ upon (within) the pants 14a, is an equivalent manner as depicted in FIG. 1.

It is important to understand that the above description of the personal audio system 10 of the present invention is exemplary only, and other equivalent arrangements may be provided by skilled artisans. Therefore, while the currently preferred embodiments of the present invention have been described and illustrated, those skilled in the art will recognize that other and further modifications may be made without departing from the present invention, and it is intended to claim all modifications and variations as fall within the scope of the invention.

What is claimed is:

1. A personal audio system included within an article of clothing, which when being worn, enables audio information to be readily delivered to a wearer, the personal audio system comprising;
(a) the article of clothing;
(b) an audio unit suitably fixed to the article of clothing so as to be supported thereby;
(c) at least one speaker element, also suitably fixed to and supported by the article of clothing; and
(d) coupling means to enable each included speaker element to be operatively coupled to the audio unit to enable audio information to be coupled from the audio unit to the speaker elements and audibly delivered to the wearer.

2. The personal audio system according to claim 1, wherein speaker elements are provided at a location upon the article of clothing to facilitate the delivery of low volume audio information to the wearer.

3. The personal audio system according to claim 1, further including a discrete battery pack, supportable within a holder provided by the article of clothing, that may be quickly replaced when the batteries therein are drained.

4. The personal audio system according to claim 3, wherein the battery pack utilizes rechargeable batteries.

5. The personal audio system according to claim 1, wherein the audio unit includes pressure sensitive switch means to enable the wearer to quickly and conveniently adjust the settings of the audio unit, as required.

6. The personal audio system according to claim 5, wherein the audio unit supports and will accept at least one of the following audio sources:
(a) an audio cassette;
(b) a CD-ROM disk;
(c) wireless audio transmissions; and
(d) optical audio transmissions.

7. A personal audio system that may be conveniently worn by a wearer to enable audio information to be audibly delivered to the wearer, the personal audio system comprising;
(a) an article of clothing;
(b) an audio unit located within and suitably fixed to the article of clothing so as to be supported thereby;
(c) at least one speaker element located within and suitably fixed to and supported by the article of clothing in an unseen manner;
(d) each speaker element operatively coupled to the audio unit by coupling means to enable each speaker element to receive audio information from the audio unit that is audibly delivered to the wearer.

8. The personal audio system according to claim 7, wherein the audio unit and speaker elements are removably fixed to the article of clothing.

9. The personal audio system according to claim 8, further including a rechargeable battery pack that may be quickly replaced when necessary.

10. The personal audio system according to claim 7, wherein the audio unit includes pressure sensitive switch means to enable the wearer to quickly and conveniently adjust the settings of the audio unit, as required for desired operation.
